(19) United States
(12) Patent Application Publication
(10) Pub. No.: US 2005/0018964 A1
(43) Pub. Date: Jan. 27, 2005

(54) Compensation of Bragg wavelength shift in a grating assisted direct coupler

(76) Inventor: Yu Chen, San Jose, CA (US)

Correspondence Address: PERKINS COIE LLP;PATENT-SEA, P.O. BOX 1247, SEATTLE, WA, 98111-1247, US

(21) Appl. No.: 10/627,323

(22) Filed: Jul. 24, 2003

(51) Int. Cl. G02B 6/34

(52) U.S. Cl. 385/37

(57) ABSTRACT

A method and apparatus for compensating for a Bragg wavelength shift in a grating assisted direct coupler is disclosed. The direct coupler includes an input waveguide and an output waveguide. The output waveguide has formed thereon a Bragg grating. By varying the characteristics of the Bragg grating, such as by applying a temperature gradient or a strain gradient, the Bragg wavelength shift can be compensated for. Alternatively, the periodicity of the Bragg grating can be varied.

### BACKGROUND OF THE INVENTION

1. Technical Field of the Invention

This invention relates generally to planar lightwave circuits, and more particularly, relates to planar lightwave circuits based on a grating assisted direct coupler.

2. Description of the Prior Art

Grating assisted direct couplers have been applied in optical signal filtering and switching. See K. O. Hill and G. Meltz, “Fiber Bragg grating technology fundamentals and overview”, Lightwave Technology Journal, Vol. 15, August, 1997. See also our pending U.S. patent application Ser. No. 10/177,632 filed Jun. 19, 2002 entitled “Waveguide Grating-Based Wavelength Selective Switch Actuated by Micro-Electro-Electromechanical System” to Zhang et al., incorporated by reference herein in its entirety.

The Bragg wavelength is an important characteristic property of grating based devices. The optical behavior of gratings is conventionally described by a simplified coupled mode theory. The conventional simple coupled mode theory has been successful in describing various grating devices. However, it has been found that the conventional simple coupled mode theory oversimplifies the mode interactions in the case of grating on direct coupler structures. As a result, the Bragg wavelength is not calculated correctly or accurately.

Rigorous coupled mode theory was then formulated for the grating assisted direct coupler. Subsequent modeling and simulation revealed that the Bragg wavelength shifts from the value obtained from conventional coupled mode theory. This Bragg wavelength shift may be referred as the effective Bragg wavelength shift due to direct coupler structure.

There are consequences to device performance due to the effective Bragg wavelength shift. It will affect the spectral position and shape of the grating assisted direct coupler. Therefore it is desirable to find methods to correct the effective Bragg wavelength shift.

### BRIEF DESCRIPTION OF THE DRAWINGS

FIG. 1A is a top view of a grating assisted direct coupler.

FIG. 1B is the reflective spectrum of a grating assisted direct coupler.

FIG. 2A is a top view of a grating assisted direct coupler with apodization.

FIG. 2B is the reflective spectrum of a grating assisted direct coupler with apodization.

FIG. 3 is a top view of gratings having a varied grating period.

FIG. 4 is a top view of gratings with a uniform grating period and varied refractive index induced by a temperature gradient.

FIG. 5 is a top view of gratings with uniform grating period and varied refractive index induced by a mechanic strain.

FIG. 6 are simulation results showing the relationship between Bragg wavelength shift and the self-coupling coefficient of the waveguide.

### DETAILED DESCRIPTION OF THE PREFERRED EMBODIMENT

In the following description, numerous specific details are provided to provide a thorough understanding of the embodiments of the invention. One skilled in the relevant art will recognize, however, that the invention can be practiced without one or more of the specific details, or with other methods, components, etc. In other instances, well-known structures or operations are not shown or described in detail to avoid obscuring aspects of various embodiments of the invention.

Reference throughout the specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout the specification are not necessarily all referring to the same embodiment. Furthermore, the particular features, structures, or characteristics may be combined in any suitable manner in one or more embodiments.

The present invention discloses methods and apparatus to correct for the Bragg wavelength shift in a grating assisted direct coupler. The methods include changing the grating period or changing the refractive index of the material, such as by inducing a temperature gradient and/or a mechanical stress gradient. The correction of the Bragg wavelength shift avoids inaccuracy in the center wavelength position and the spectral shape distortion of optical filters based on a grating assisted direct coupler.

A grating is a versatile structure that finds numerous applications. In particular, narrow band and small side-lobe optical filters can be readily made using a Bragg grating. Writing a grating in a planar waveguide is to introduce a periodic variation of refractive index. It can happen to various waveguide structures. In the following, we will focus on the Bragg grating written on direct waveguide couplers.

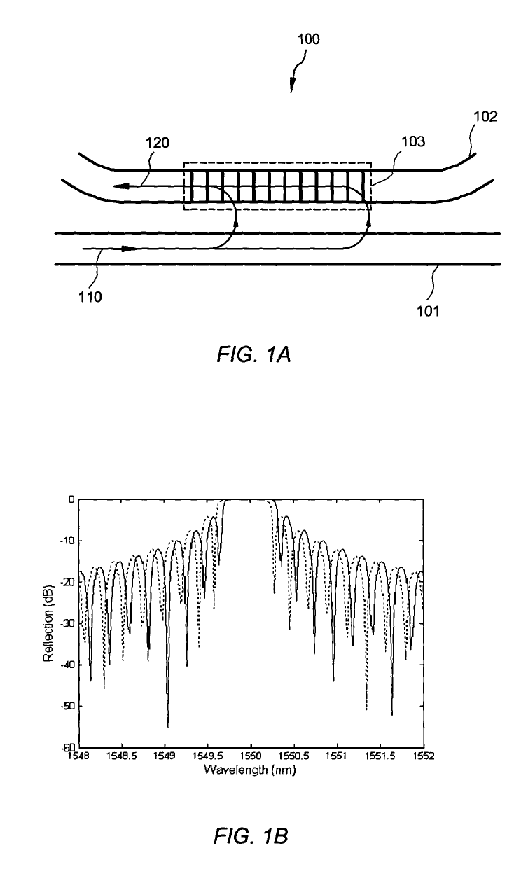

FIG. 1A shows a top view of a grating assisted direct coupler with grating written on one arm. Optical signal 110 is input into the waveguide 101 and backward coupled onto waveguide 102 and exit at port 120. The grating 103 is written on waveguide 102 and has uniform grating period.

The optical performance of the grating showed in FIG. 1A is governed by the following coupled mode equations. See J. P. Webber, “Spectral Characteristics of Coupled Waveguide Bragg Reflection Tunable Optical Filters”, IEEE Proceedings-J, Vol. 140, No. 5, October 1993.

$$\begin{matrix}\frac{ⅆ {F}_{1}}{ⅆ z} = - j {κ}_{11} {G}_{1} ( z ) {ⅇ}^{j 2 Δ {β}_{1} z} - j {κ}_{12} {G}_{2} ( z ) {ⅇ}^{j ( Δ {β}_{1} + Δ {β}_{2} ) z} \\ \frac{ⅆ {F}_{2}}{ⅆ z} = - j {κ}_{12} {G}_{1} ( z ) {ⅇ}^{j ( Δ {β}_{1} + Δ {β}_{2} ) z} - j {κ}_{22} {G}_{2} ( z ) {ⅇ}^{j 2 Δ {β}_{2} z} \\ \frac{ⅆ {G}_{1}}{ⅆ z} = j {κ}_{11} {F}_{1} ( z ) {ⅇ}^{- j 2 Δ {β}_{1} z} + j {κ}_{12} {F}_{2} ( z ) {ⅇ}^{- j ( Δ {β}_{1} + Δ {β}_{2} ) z} \\ \frac{ⅆ {G}_{2}}{ⅆ z} = j {κ}_{12} {F}_{1} ( z ) {ⅇ}^{- j ( Δ {β}_{1} + Δ {β}_{2} ) z} - j {κ}_{22} {F}_{2} ( z ) {ⅇ}^{- j 2 Δ {β}_{2} z}\end{matrix}$$

where Fᵢ are the amplitudes of forward propagation modes; Gᵢ are the amplitudes of backward propagation modes; κᵢⱼ are the coupling coefficients; and Δβᵢ are determined by the following formula:

$$Δ {β}_{i} = {β}_{i} - \frac{π}{Λ}$$

where βᵢ is the propagation constant and Λ being the grating period.

The above equations require rigorous numerical solution. In practice the simplified coupled-mode equations as shown below are often used. See H. Kogelink, “Coupled Mode Theory”, Bell System Technology Journey, 55, 1976.

$$\begin{matrix}\frac{ⅆ {F}_{2}}{ⅆ z} = - j {κ}_{12} {G}_{1} ( z ) {ⅇ}^{j ( Δ {β}_{1} + Δ {β}_{2} ) z} \\ \frac{ⅆ {G}_{1}}{ⅆ z} = j {κ}_{12} {F}_{2} ( z ) {ⅇ}^{- j ( Δ {β}_{1} + Δ {β}_{2} ) z}\end{matrix}$$

The simplified coupled theory is successful in predicting the optical behaviors of many grating devices, for instance, the most commonly used single waveguide grating. The problem with the simplified equations, however, is that they may overlook some detailed physics of grating devices, specifically for the case of a grating assisted direct coupler.

FIG. 1B shows the grating spectrums of a uniform grating calculated by using the rigorous and simplified models respectively. The solid line shows the reflection spectrum calculated by the simplified coupled mode theory and the dashed line by the rigorous coupled mode theory.

From the simulation results, it can be seen that there exists Bragg wavelength shift caused by the structure of the grating assisted direct coupler itself. The Bragg wavelength is defined as the wavelength where the reflection spectrum reaches its peak. Since Bragg wavelength shifting can be caused by various factors such as material refractive index fluctuation and any geometrical variations that affect modal index, therefore, in practice, Bragg wavelength shifting caused by a direct coupler structure may not be easy to identify from the Bragg wavelength shifts caused by other factors.

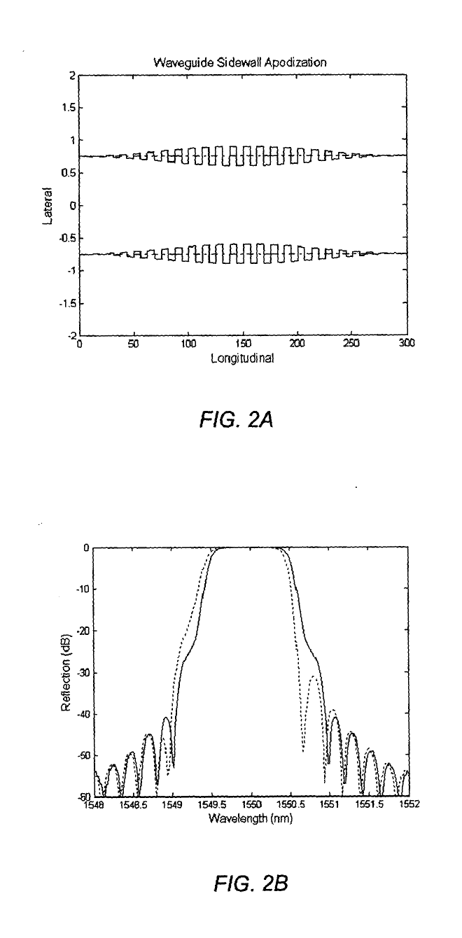

One way to verify the existence of such a Bragg wavelength shift is by using an apodized grating. The top view of a grating having a sidewall apodization is shown in FIG. 2A. See J. T. Hastings, M. H. Lim, J. G. Goodberlet, and H. I. Smith, “Optical Waveguide with Apodized Sidewall Gratings via Spatial-Phase-Locked E-Beam Lithography”, 46^{th} International Conference on Electron, Ion, and Photon Beam Technology and Nano-fabrication, Anaheim, Calif. May, 2002. Its reflection spectrum is shown in FIG. 2B. In this sidewall apodization structure, the grating is etched in the waveguide sidewall and the grating depths vary. Apodization is often used to suppress the spectral side-lobe. As shown in FIG. 2B, the side lobe is suppressed to about 25 dB from around 7 dB as shown in FIG. 1B.

The reflection spectrum of the symmetrically apodized grating structure as shown in FIG. 2A is expected to be symmetrical (the solid curve in FIG. 2B). However, as revealed by the present invention, when the Bragg wavelength shift induced by a direct coupler structure is presented, the symmetry is destroyed as shown by the dashed curve in FIG. 2B. It is desirable to find ways to correct or compensate this kind of Bragg wavelength shift.

In accordance with the present invention, it has been found that the Bragg wavelength is determined by the following formula.
λ_{BG}=(n₁+n₂)Λ−δλ_{BG}
where n1 and n2 are the modal indexes of the first mode and the second mode in the direct coupler, Λ is the grating period, λ_{BG} is the shifted Bragg wavelength, and δλ_{BG} is the Bragg wavelength shift due to mode interaction in the direct coupler, which is not present in the simplified coupled mode theory.

Therefore, for a specified Bragg wavelength, we need either to increase the mode indexes or grating period to compensate the Bragg wavelength shift caused by the direct coupler structure. In implementation, a nominal wavelength to be coupled is first translated to a nominal grating period using conventional optical theory. Once the nominal grating period has been determined, then the nominal grating period can be increased by some amount to compensate for the Bragg wavelength shift. The resulting grating period can be referred to as the adjusted grating period.

For a uniform period grating as shown in FIG. 1A, increasing the grating period will compensate for this Bragg wavelength shift. In particular, it has been found that the wavelength shift and the self-coupling coefficient of the waveguide. The relationship was developed using computer simulation, the results of which are shown in FIG. 6. In general, the wavelength shift is roughly proportional to the square of the self-coupling coefficient of the waveguide with grating on it. Further, because the self-coupling coefficient of a uniform grating waveguide can be calculated, the Bragg wavelength shift can be estimated using the simulation data of FIG. 6. Once the Bragg wavelength shift has been estimated, the following equation can be used to calculate how much the grating period must be increased to compensate for the wavelength shift:
λ_{BG}=(n₁+n₂)Λ−δλ_{BG}

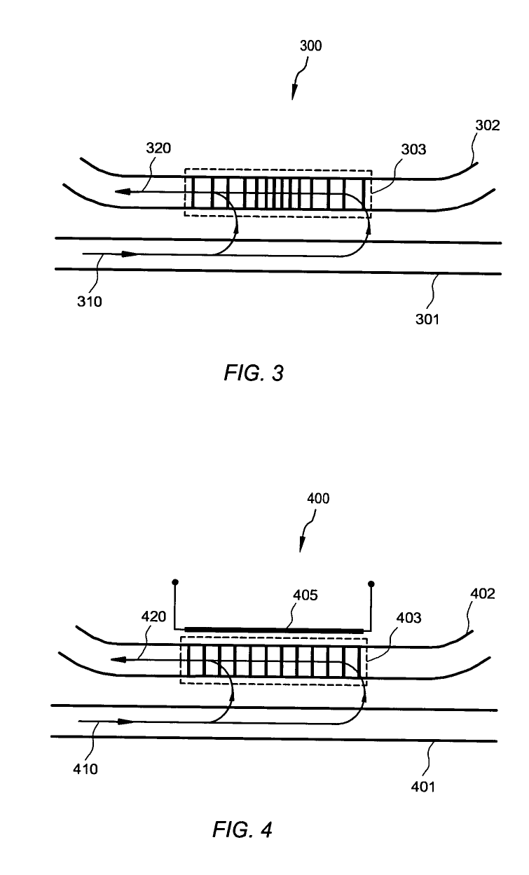

In the case of an apodized grating, the coupling strength varies along the grating direction. To compensate the varying Bragg wavelength shift, a varying grating period can be used as shown in FIG. 3. However, due to the nature of the Bragg wavelength shift (caused by multiple mode interaction), it is difficult to find simple relationships for non-uniform grating cases. Thus, in order to determine the amount of compensation needed with respect to using strain, temperature, or period is in one embodiment done using a heuristic approach using simulations.

In FIG. 4, a temperature gradient is used to change the material index (therefore optical modal indexes) along the grating direction. This index change can be used to compensate for the Bragg wavelength shift discussed above. The material refractive index change due to the temperature gradient can be uniform or non-uniform along the grating. As noted above, the precise temperature to provide the needed compensation should be determined using multi-variate computer simulations. However, it has been found that applying either a uniform temperature or a temperature gradient is a viable method for compensation.

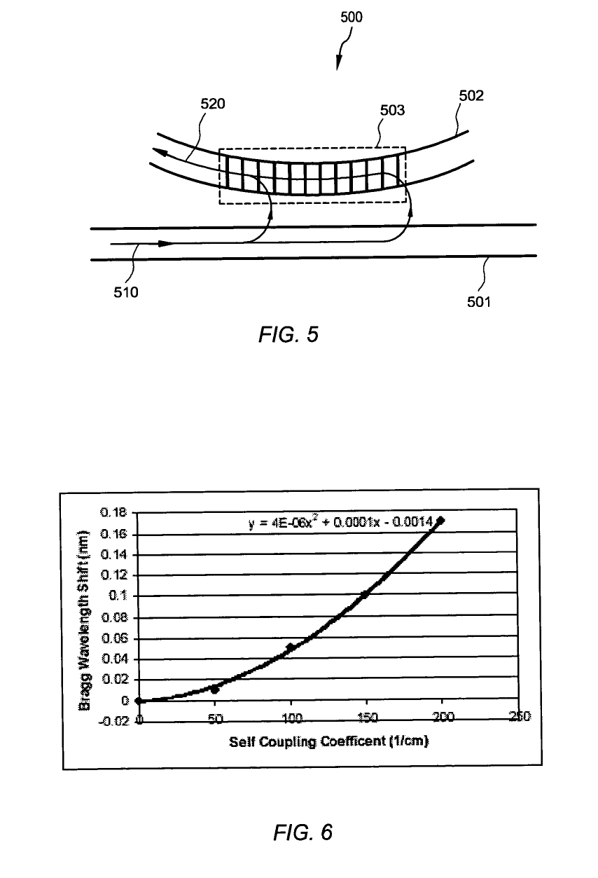

In FIG. 5, a stress gradient is used to change the material index (therefore optical modal indexes) along the grating direction. This index change can be used to compensate the Bragg wavelength shift discussed above. Again, the material refractive index change due to the stress gradient can be uniform or non-uniform along the grating. As noted above, the precise strain to provide the needed compensation should be determined using multi-variate computer simulations. However, it has been found that applying either a uniform strain or a strain gradient is a viable method for compensation.

The above described wavelength compensation techniques can be applied in the specific application of a grating assisted direct coupler, though other applications are also contemplated. While in many applications the direct coupler is a fixed device that is always “on”, the direct coupler can be made to be switchable, such that the input waveguide carrying the input optical signal can be selectively coupled to the output waveguide. For example, as seen in our co-pending U.S. patent application Ser. No. 10/438,665 filed May 14, 2003 entitled “SWITCHABLE OPTICAL DISPERSION COMPENSATOR USING BRAGG-GRATING”, incorporated by reference herein in its entirety, various methods for coupling and decoupling an input waveguide and an output waveguide are described.

From the foregoing, it will be appreciated that specific embodiments of the invention have been described herein for purposes of illustration, but that various

1. An apparatus comprising:
an input waveguide for carrying an optical signal having a nominal wavelength; and
an output waveguide having a Bragg grating disposed proximate to said input waveguide, said Bragg grating having an adjusted grating period that has been increased from a nominal grating period to compensate for a Bragg wavelength shift.

2. The apparatus of claim 1 wherein said Bragg grating is implemented as a uniform grating having means for applying a temperature gradient to said uniform grating.

3. The apparatus of claim 1 wherein said Bragg grating is implemented as a uniform grating having means for applying a strain gradient to said uniform grating.

4. The apparatus of claim 1 wherein said Bragg grating has a higher periodicity in its middle portion than in its outer portions.

5. The apparatus of claim 1 wherein said Bragg grating is an apodized Bragg grating.

6. The apparatus of claim 1 wherein said Bragg grating has a variable grating period.

7. A grating assisted direct coupler comprising:
an input waveguide carrying an optical signal having a nominal wavelength;
an output waveguide having a variable period Bragg grating for coupling said optical signal into said output waveguide, said variable period Bragg grating having an adjusted variable grating period that has been changed from a nominal variable grating period to compensate for a Bragg wavelength shift.

8. The direct coupler of claim 7 further including means for applying a temperature gradient to said variable period Bragg grating.

9. The direct coupler of claim 7 further including means for applying a strain gradient to said variable period Bragg grating.

10. The direct coupler of claim 7 wherein said variable period Bragg grating has a higher periodicity in its middle portion than in its outer portions.

11. The direct coupler of claim 7 wherein said variable period Bragg grating is an apodized Bragg grating.

12. A method for compensating for a Bragg wavelength shift in a grating assisted direct coupler having an input waveguide and an output waveguide, said output waveguide having a Bragg grating formed thereon, the method comprising applying a temperature gradient to said Bragg grating.

13. A method for compensating for a Bragg wavelength shift in a grating assisted direct coupler having an input waveguide and an output waveguide, said output waveguide having a Bragg grating formed thereon, the method comprising applying a stress gradient to said Bragg grating.

14. A method for compensating for a Bragg wavelength shift in a grating assisted direct coupler having an input waveguide and an output waveguide, said output waveguide having a Bragg grating formed thereon, the method comprising varying the periodicity of said Bragg grating.
